(19) United States
(12) Patent Application Publication
(10) Pub. No.: US 2009/0204896 A1
(43) Pub. Date: Aug. 13, 2009

(54) Background Particle Manipulation Responsive to the Contents of a Selected Folder

(75) Inventor: Rui Yamagami, Malmo (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/027,297

(22) Filed: Feb. 7, 2008

(51) Int. Cl. G06F 3/00

(52) U.S. Cl. 715/700

(57) ABSTRACT

A user interface for an electronic device is described herein. The user interface varies properties of displayed background particles to provide the user with an indication of the contents of a selected folder without requiring the user to open the selected folder. In one embodiment, the electronic device varies the number of displayed background particles based on the number of items in a selected folder. Alternatively or additionally, the electronic device of the present invention may vary the size, color, shape, animation speed, etc., of displayed background particles based on the type, size, etc., of the contents of the selected folder.

### BACKGROUND

The present invention generally relates to user interfaces for electronic devices, and more particularly relates to user interfaces that provide information about folder content.

Electronic devices typically include a display to convey information to a user about current operations or options available to the user. For example, the display may display a current song, entered text information, etc. Further, the display may display a plurality of folder icons to enable the user to select and access the contents of a desired folder. In some cases, the users may be interested in general information about the content of a particular folder, such as folder size, number of items in the folder, etc. To obtain such information, the user typically executes a series of input steps related to the desired folder. For example, the user may select a folder, open the folder, and view the displayed information regarding the contents of the folder. In some cases the desired information may be displayed in an information bar at the bottom of the display. Regardless, the multiple operations required to obtain this information are cumbersome, and therefore, undesirable.

### SUMMARY

The present invention provides a user interface for an electronic device. The user interface includes a background with one or more particles. The particles may comprise geometric shapes, icons, text, or other graphical elements. The user interface varies properties of displayed background particles to provide the user with an indication of the contents of a selected folder without requiring the user to actually open the folder. For example, the electronic device of the present invention may vary the number of displayed background particles based on the number of items in a selected folder. Alternatively or additionally, the electronic device of the present invention may vary the size, color, shape, animation speed, etc., of displayed background particles based on the type, size, etc., of the content in the selected folder.

### BRIEF DESCRIPTION OF THE DRAWINGS

FIG. 1 shows a bock diagram for an exemplary electronic device.

FIGS. 2A-2C show exemplary displays according to one exemplary embodiment of the present invention.

FIGS. 3A-3C show exemplary displays according to another exemplary embodiment of the present invention.

FIGS. 4A-4C show exemplary displays according to another exemplary embodiment of the present invention.

FIG. 5 shows a flow chart for a process according to one exemplary embodiment of the present invention.

### DETAILED DESCRIPTION

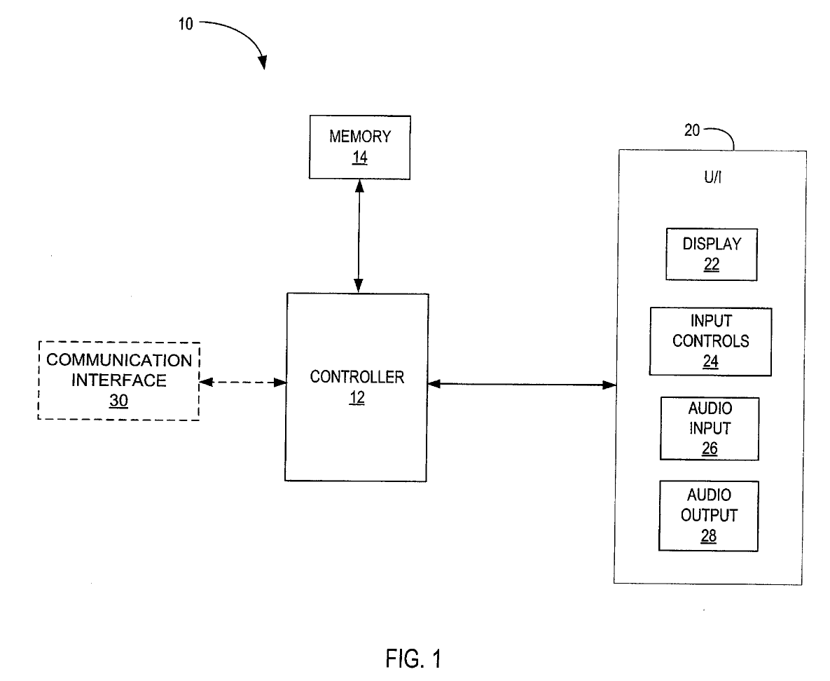

FIG. 1 shows an exemplary electronic device 10 according to the present invention. The electronic device 10 may comprise any electronic device with a display, including but not limited to, a cellular telephone, digital music player, personal data assistant, television, digital video recorder, personal computer, digital camera, etc.

Electronic device 10 comprises a controller 12, memory 14, and user interface 20. The electronic device 10 may also include a communication interface 30 for communicating with external devices over a communication network. Controller 12 controls the overall operation of the device 10 according to instructions and data stored in memory 14. The control functions may be implemented in a single controller, or in multiple controllers. Suitable controllers may include, for example, both general purpose and special purpose controllers and digital signal processors. Memory 14 represents the entire hierarchy of memory in device 10, and may include both random access memory (RAM) and read-only memory (ROM). The user interface 20 provides an input/output interface for the user to communicate with the device 10. Communication interface 30 may comprise any communication interface, including but not limited to, a wireless interface, e.g., cellular telephone, Bluetooth, IR, or other wireless interface, or a wired interface, e.g., Ethernet, USB, or other wired interface.

User interface 20 comprises a display 22, input controls 24, an audio input 26, and an audio output 28. Controller 12 outputs information to display 22 for viewing by a user and receives user input from one or more input controls 24. Input controls 24 include an alphanumeric keypad and other control elements, such as a joystick, button controls, and/or dials that allow the operator to dial numbers, enter commands, and select options from menu systems. Further, the input controls 24 may include touch screen functions implemented with display 22. Audio input 26, e.g., a microphone, converts user speech into electrical audio signals, and audio output 28, e.g., a speaker, converts audio signals into audible sounds.

In addition to storing instructions, memory 14 may store data for the user in files. For example, the memory 14 may store photographs, music, contacts, notes, video, games, etc. Further, folders may be stored in memory 14 to organize the different files within the memory 14. For example, a PHOTO folder in memory 14 may store image files. To enable a user to access items in a particular folder, the display 22 may display one or more folders using text, icons, etc. Conventionally, if the user wants information about the contents of a folder, the user selects and opens the folder to view the contents and any related information. This may be undesirably cumbersome.

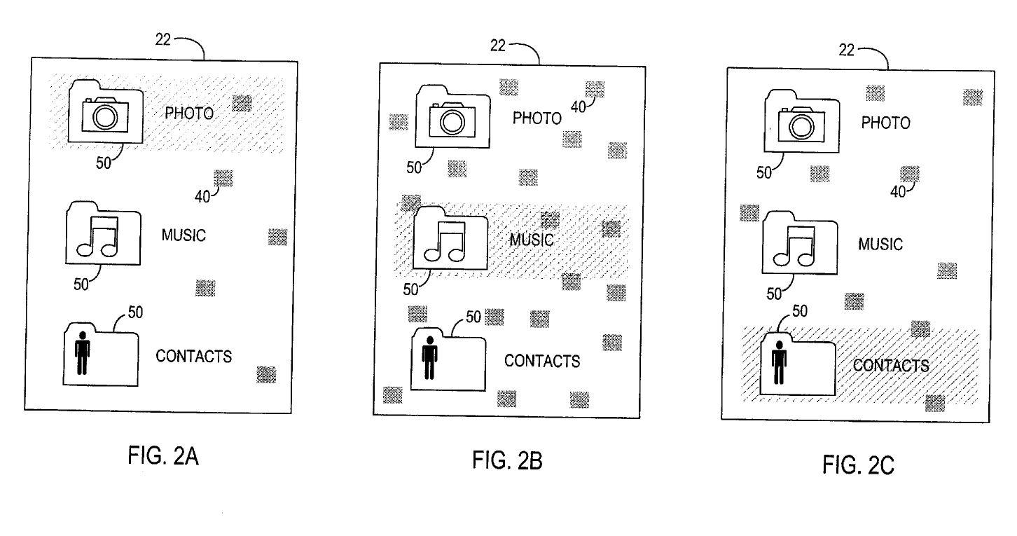

The present invention provides a method to obtain information about the contents of a selected folder without the need to open the folder. Visual elements on the user desktop are changed depending on the contents of a selected folder to provide information about the content of the selected folder. For example, the display 22 includes a background with one or more particles 40 (FIGS. 2A-4C). The particles 40 may comprise geometric shapes, icons, text, or other graphical elements. The controller 12 varies a property, e.g., size, number, color, shape, animation speed, etc., of displayed background particles 40 to provide the user with an indication of the contents of a selected folder, e.g., number of items in the folder, the size of the folder, the size of the items in the folder, the data type, etc. More than one property may be varied.

FIGS. 2A-2C illustrate one example of the present invention where the controller 12 varies the number of displayed background particles 40 based on the number of items in a selected folder 50. For this embodiment, the number of background particles 40 may be proportional to the number of items in the selected folder 50. For example, one particle 40 may represent between up to five items in the selected folder 50. In some embodiments, the number of background particles 40 may be equivalent to the number of items in the selected folder 50. In FIG. 2A, the display 22 shows four background particles 40 (representing e.g., sixteen to twenty items) when the PHOTO folder 50 is selected. The display 22 in FIG. 2B shows nineteen background particles 40 (representing e.g., ninety-one to ninety-five items) when the MUSIC folder 50 is selected, and the display in FIG. 2C shows nine background particles 40 (representing e.g., forty-one to forty-five items) when the CONTACTS folder 50 is selected. Thus, by selecting different folders 50 the user may quickly discern that the MUSIC folder 50 contains more items than either the PHOTO or CONTACTS folders 50 based on the number of displayed particles 40.

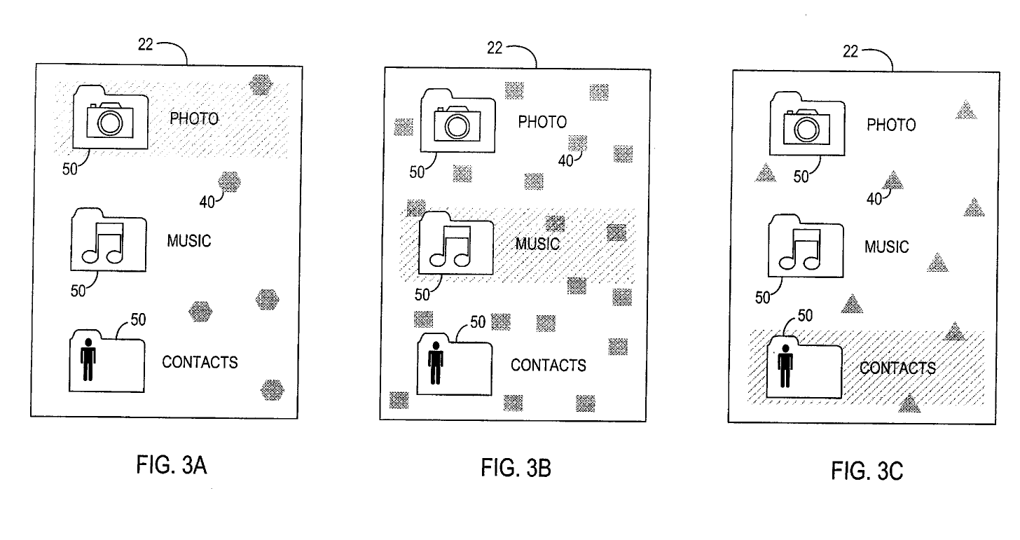

FIGS. 3A-3C illustrate another example of the present invention where controller 12 varies the shape of the displayed background particles 40 based on the type of items in a selected folder 50. For example, hexagonal particles 40 may correspond to image files, rectangular particles 40 may correspond to audio files, and triangular particles 40 may correspond to text files. Thus, in FIG. 3A, the display 22 shows hexagonal background particles 40 when the PHOTO folder 50 is selected to indicate that the PHOTO folder 50 contains image files. The display 22 in FIG. 3B shows rectangular background particles 40 when the MUSIC folder 50 is selected, and the display 22 in FIG. 3C shows triangular background particles 40 when the CONTACTS folder 50 is selected. While not explicitly shown, it will be appreciated that some folders 50 may contain different types of files, and therefore, the display 22 may show particles 40 having different shapes. For example, the display 22 may display both triangular and hexagonal particles 40 when the CONTACTS folder 50 is selected to indicate that the CONTACTS folder 50 includes both text and image files.

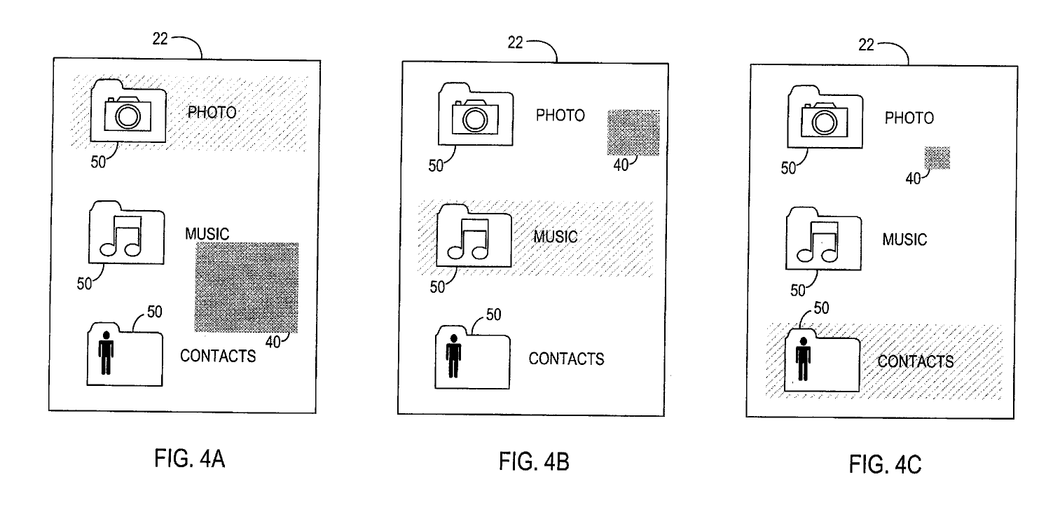

FIGS. 4A-4C illustrate another example of the present invention where controller 12 varies the size of a displayed background particle 40 based on the size of the selected folder 50. In FIG. 4A, the display 22 shows one large background particle 40 when the PHOTO folder 50 is selected, the display 22 in FIG. 4B shows one medium background particle 40 when the MUSIC folder 50 is selected, and the display 22 in FIG. 4C shows one small background particle 40 when the CONTACTS folder 50 is selected. Thus, the displayed background particles 40 in FIGS. 4A-4C convey that the PHOTO folder 50 contains more data, and therefore, requires more memory space than the MUSIC and CONTACTS folders 50.

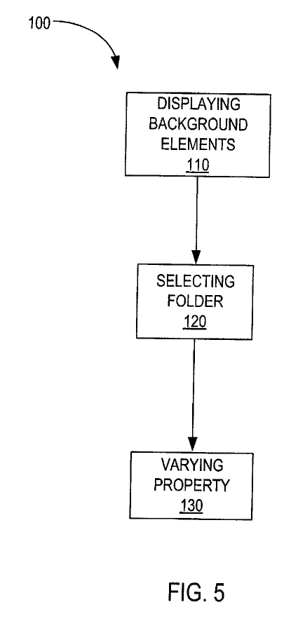

FIG. 5 shows one exemplary process 100 for providing the graphical information illustrated by the above examples. The display 22 displays a background with one or more background particles 40 (block 110). The controller 12 selects one of the folders 50 (block 120). In some embodiments, the controller 12 may select the folder 50 responsive to user input. The controller 12 varies at least one property of the displayed background particle(s) 40, e.g., size, number, color, shape, animation speed, etc., based on the content of the selected folder 50 (block 130).

It will be appreciated that the controller 12 may vary properties of the background particles 40 other than those explicitly described herein. For example, the controller 12 may vary the animation speed of one or more background particles 40 dependent on the number of items in a selected folder 50. In this example the animation speed of the background particle(s) 40 may increase or decrease proportional to the number of items in the selected folder 50. For example, the controller 12 may display one or more particles 40 with a fast animation speed when a selected folder 50 contains a large number of items. In another example, the controller 12 may vary the color of the displayed background particle(s) 40 based on the number of items in the selected folder 50.

Further, it will be appreciated that the controller 12 may vary multiple different properties of the displayed background particles 40 to convey different information about the content of the selected folder 50. For example, the controller 12 may vary the number of the background particles 40 based on the number of items in the selected folder 50, and may further vary the sizes of the displayed particle(s) 40 based on the sizes of the items in the selected folder 50. Alternatively, the controller 12 may vary the number of the background particles 40 based on the number of items in the selected folder 50, may further vary the shape(s) of the displayed particles 40 based on the type(s) of data contained in the selected folder. It will be appreciated that any combination of shape, size, color, number, animation speed, or other properties applicable to the background particles 40 may be varied to convey information about the content of the selected folder 50.

It will be appreciated that the present invention is not limited to the particle properties or folder content information described herein. Thus, the present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A user-interface method for an electronic device, the method comprising:
displaying a background having one or more background particles; and
varying at least one property of the background particles based on contents of a user-selected folder.

2. The method of claim 1 wherein varying at least one property of the one or more background particles comprises varying a number of the background particles based on the content of the user-selected folder.

3. The method of claim 2 wherein varying the number of the background particles comprises varying the number of the background particles based on a number of items in the user-selected folder.

4. The method of claim 1 wherein varying at least one property of the background particles comprises varying a size of the background particles based on the content of the user-selected folder.

5. The method of claim 1 wherein varying at least one property of the background particles comprises varying a shape of the background particles based on the content of the user-selected folder.

6. The method of claim 1 wherein varying at least one property of the background particles comprises varying a color of the background particles based on the content of the user-selected folder.

7. The method of claim 1 wherein varying at least one property of the background particles comprises varying an animation speed of the background particles based on the content of the user-selected folder.

8. The method of claim 1 wherein varying at least one property of the background particles comprises varying at least one property of the background particles based on a number of items in the user-selected folder.

9. The method of claim 1 wherein varying at least one property of the background particles comprises varying at least one property of the background particles based on a size of items in the user-selected folder.

10. The method of claim 1 wherein the electronic device comprises a cellular telephone.

11. An electronic device comprising:
a display to display a background having one or more background particles; and
a control unit configured to vary at least one property of the background particles based on contents of a user-selected folder.

12. The electronic device of claim 11 wherein the control unit varies at least one property of the background particles by varying a number of the background particles based on the content in the user-selected folder.

13. The electronic device of claim 12 wherein the control unit varies the number of the background particles by varying the number of the background particles based on a number of items in the user-selected folder.

14. The electronic device of claim 11 wherein the control unit varies at least one property of the background particles by varying a size of the background particles based on the content in the user-selected folder.

15. The electronic device of claim 11 wherein the control unit varies at least one property of the background particles by varying a shape of the background particles based on the content in the user-selected folder.

16. The electronic device of claim 11 wherein the control unit varies at least one property of the background particles by varying a color of the background particles based on the content in the user-selected folder.

17. The electronic device of claim 11 wherein the control unit varies at least one property of the background particles by varying an animation speed of the background particles based on the content in the user-selected folder.

18. The electronic device of claim 11 wherein the control unit varies at least one property of the background particles by varying at least one property of the background particles based on a number of items in the user-selected folder.

19. The electronic device of claim 11 wherein the control unit varies at least one property of the background particles by varying at least one property of the background particles based on a size of items in the user-selected folder.

20. The electronic device of claim 11 wherein the electronic device comprises a cellular telephone.
